(19) United States
(12) Patent Application Publication
(10) Pub. No.: US 2021/0342808 A1
(43) Pub. Date: Nov. 4, 2021

(54) UTILIZING MACHINE LEARNING TO DETERMINE WHETHER AN IN-PERSON CUSTOMER FOLLOWS A MERCHANT ON SOCIAL MEDIA

(71) Applicant: Capital One Services, LLC, McLean, VA (US)

(72) Inventors: Abdelkader M'Hamed BENKREIRA, New York, NY (US); Varun GUPTA, Edison, NJ (US); Tyler MAIMAN, Melville, NY (US)

(21) Appl. No.: 16/864,852

(22) Filed: May 1, 2020

(51) Int. Cl. G06Q 20/20; G06Q 50/00; G06Q 30/02; G06N 20/00

(52) U.S. Cl. CPC G06Q 20/206; G06Q 50/01; G06Q 30/0236; G06N 20/00; G06Q 30/0238; G06Q 30/0201

(57) ABSTRACT

A device may receive, from a point-of-sale (POS) device, transaction data associated with a transaction between a customer and a merchant associated with the POS device. The device may determine a customer email address and other data associated with the transaction, the customer, or the merchant, based on the transaction data and customer data identifying the customer, and may process the customer email address, the other data, and social media data, with a machine learning model, to identify a social media account of the customer. The social media data may include data identifying multiple social media accounts, and the multiple social media accounts may include the social media account of the customer. The device may determine, based on the social media data, whether the social media account of the customer follows the merchant, and may perform actions based on whether the social media account follows the merchant.

### BACKGROUND

Merchants invest effort to acquire customers and to retain customers. A retention program is a strategy that focuses on an existing customer base of a merchant. Goals of a retention program include creating repeat customers, increasing frequency of purchase by the customers, increasing an average order volume per purchase by the customers, and/or the like. A retention rate is a popular metric for measuring a success of a retention program campaign.

### SUMMARY

According to some implementations, a method may include receiving, from a point-of-sale device, transaction data associated with a transaction between a customer and a merchant associated with the point-of-sale device, and determining a customer email address of the customer and other data associated with the transaction, the customer, or the merchant, based on the transaction data and customer data identifying the customer. The method may include processing the customer email address, the other data, and social media data, with a machine learning model, to identify a social media account of the customer, wherein the social media data may include data identifying a plurality of social media accounts, and wherein the plurality of social media accounts may include the social media account of the customer. The method may include determining, based on the social media data, whether the social media account of the customer follows the merchant (e.g., the customer and the merchant have a connection on social media, such as a like, a friend, a subscribe, and/or the like), and performing one or more actions based on whether the social media account of the customer follows the merchant.

According to some implementations, a device may include one or more memories, and one or more processors, communicatively coupled to the one or more memories, configured to receive, from a point-of-sale device, a name of a customer conducting a transaction with a merchant, an image of the customer, and a geographical location of the merchant. The one or more processors may process the name of the customer, the image of the customer, the geographical location of the merchant, and social media data, with a machine learning model, to identify a social media account of the customer. The one or more processors may determine, based on the social media data, whether the social media account of the customer follows the merchant, and may perform one or more actions based on whether the social media account of the customer follows the merchant.

According to some implementations, a non-transitory computer-readable medium may store one or more instructions that, when executed by one or more processors of a device, may cause the one or more processors to receive, from a point-of-sale device, transaction data associated with a transaction between a customer and a merchant associated with the point-of-sale device, and determine a customer email address of the customer and other data associated with the transaction, the customer, or the merchant, based on the transaction data and customer data identifying the customer. The one or more instructions may cause the one or more processors to process the customer email address, the other data, and social media data, with a machine learning model, to identify a social media account of the customer, wherein the machine learning model may be trained based on historical customer email addresses, historical other data, and historical social media data, wherein the social media data may include data identifying a plurality of social media accounts, and wherein the plurality of social media accounts may include the social media account of the customer. The one or more instructions may cause the one or more processors to determine, based on the social media data, whether the social media account of the customer follows the merchant, and perform one or more actions based on whether the social media account of the customer follows the merchant.

### BRIEF DESCRIPTION OF THE DRAWINGS

FIGS. 1A-1H are diagrams of one or more example implementations described herein.

FIG. 2 is a diagram illustrating an example of training a machine learning model.

FIG. 3 is a diagram illustrating an example of applying a trained machine learning model to a new observation.

FIG. 4 is a diagram of an example environment in which systems and/or methods described herein may be implemented.

FIG. 5 is a diagram of example components of one or more devices of FIG. 4.

FIGS. 6-8 are flow charts of example processes for utilizing machine learning to determine whether an in-person customer follows a merchant on social media.

### DETAILED DESCRIPTION

The following detailed description of example implementations refers to the accompanying drawings. The same reference numbers in different drawings may identify the same or similar elements.

Current retention marketing techniques include email marketing, direct mail marketing, social media marketing, and/or the like. Each of these techniques require the merchant to have a reliable contact point with a customer. However, there are few techniques for identifying social media accounts of customers, particularly for in-person customers (e.g., customers shopping within stores of merchants, rather than online). Furthermore, there is a big gap between social media followers (e.g., a customer and a merchant have a connection on social media, such as a like, a friend, a subscribe, and/or the like) of a merchant and actual customers of the merchant (e.g., social media followers of the merchant are not necessarily customers of the merchant). There are also different identities associated with social media accounts and customers (e.g., transaction card numbers, user identifiers, email addresses, and/or the like) even when the different identities are associated with the same people.

Thus, current retention marketing techniques may waste computing resources (e.g., processing resources, memory resources, communication resources, and/or the like), networking resources, and/or the like associated with attempting to accurately provide social media marketing to customers of a merchant, incorrectly identifying social media accounts of the customers, correcting the incorrect identification of the social media accounts if discovered, and/or like.

Some implementations described herein provide a processing platform that utilizes machine learning to determine whether an in-person customer follows a merchant on social media (e.g., the customer and the merchant have a connection on social media, such as a like, a friend, a subscribe, and/or the like). For example, the processing platform may receive, from a point-of-sale device, transaction data associated with a transaction between a customer and a merchant associated with the point-of-sale device, and may determine a customer email address of the customer and other data associated with the transaction, the customer, or the merchant, based on the transaction data and customer data identifying the customer. The processing platform may process the customer email address, the other data, and social media data, with a machine learning model, to identify a social media account of the customer, where the social media data may include data identifying a plurality of social media accounts, and the plurality of social media accounts may include the social media account of the customer. The processing platform may determine, based on the social media data, whether the social media account of the customer follows the merchant, and may perform one or more actions based on whether the social media account of the customer follows the merchant.

In this way, the processing platform utilizes machine learning to determine whether an in-person customer follows a merchant on social media in near-real time (e.g., while the customer is making a purchase at a store of the merchant). The processing platform may enable the merchant to identify if the customer is engaged with the merchant, a product of the merchant, and/or a service of the merchant on social media. Once this is determined, the processing platform may take additional actions, such as promoting merchant products and/or services to the social media account of the customer. This, in turn, conserves computing resources, networking resources, and/or the like that would otherwise have been wasted in attempting to accurately provide social media marketing to customers of a merchant, incorrectly identifying social media accounts of the customers, correcting the incorrect identification of the social media accounts if discovered, and/or like.

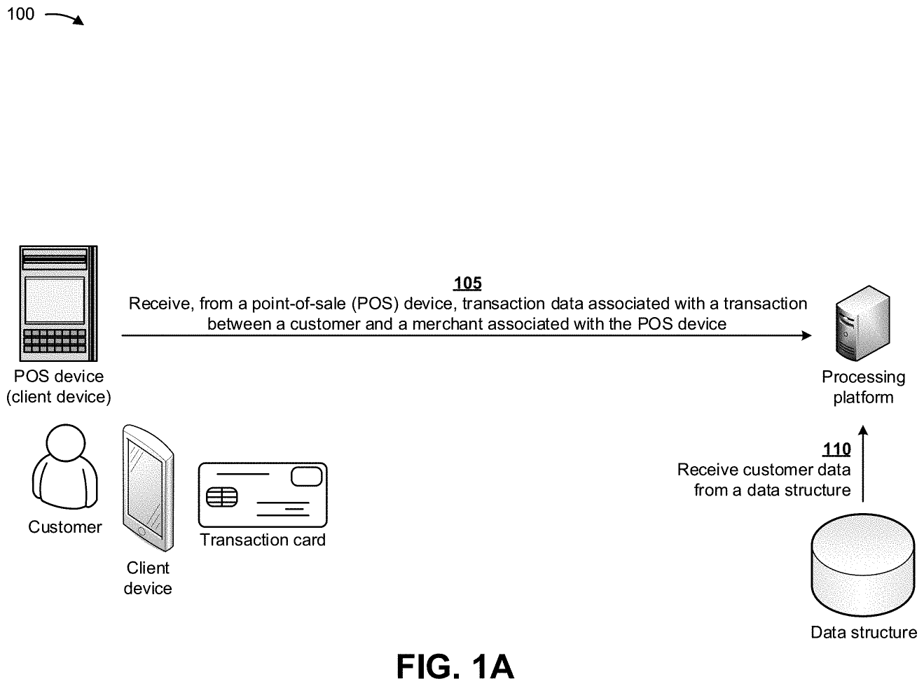

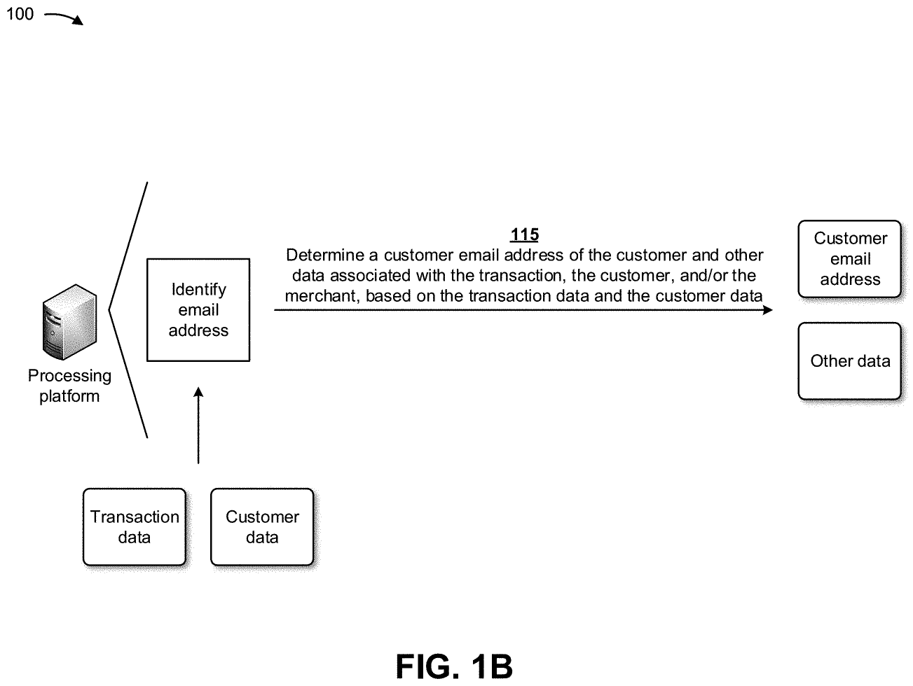

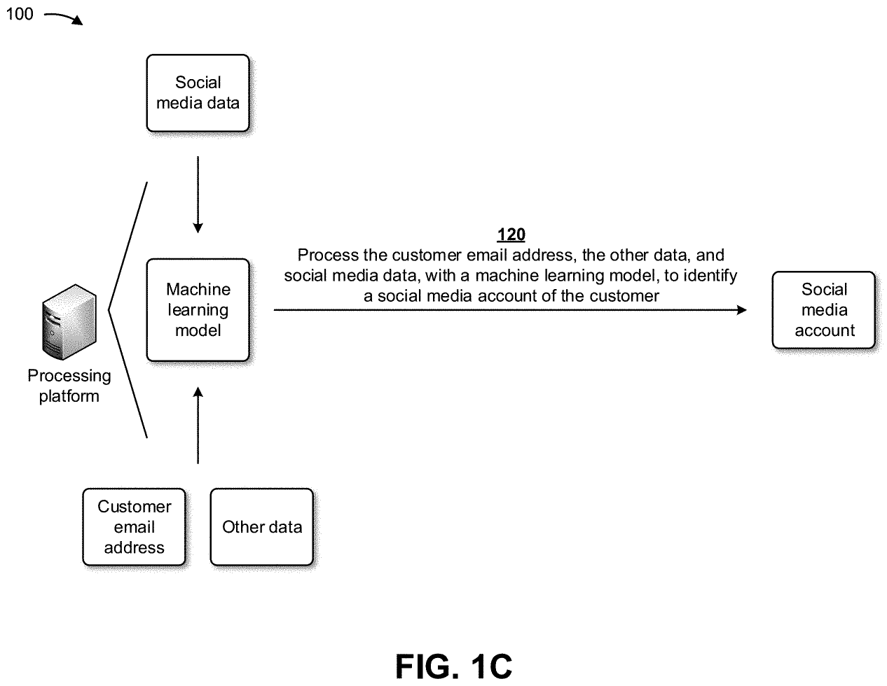

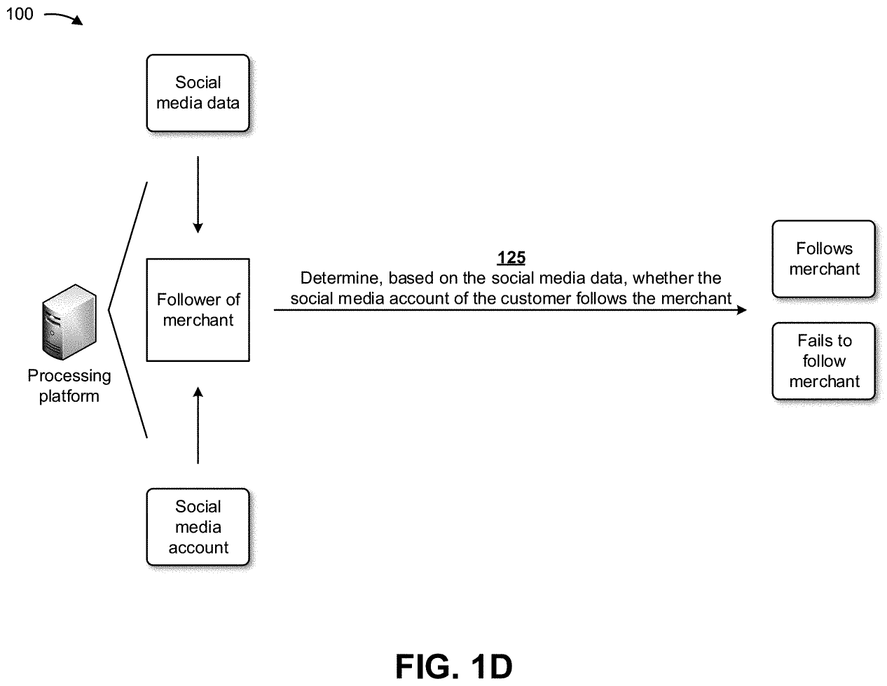

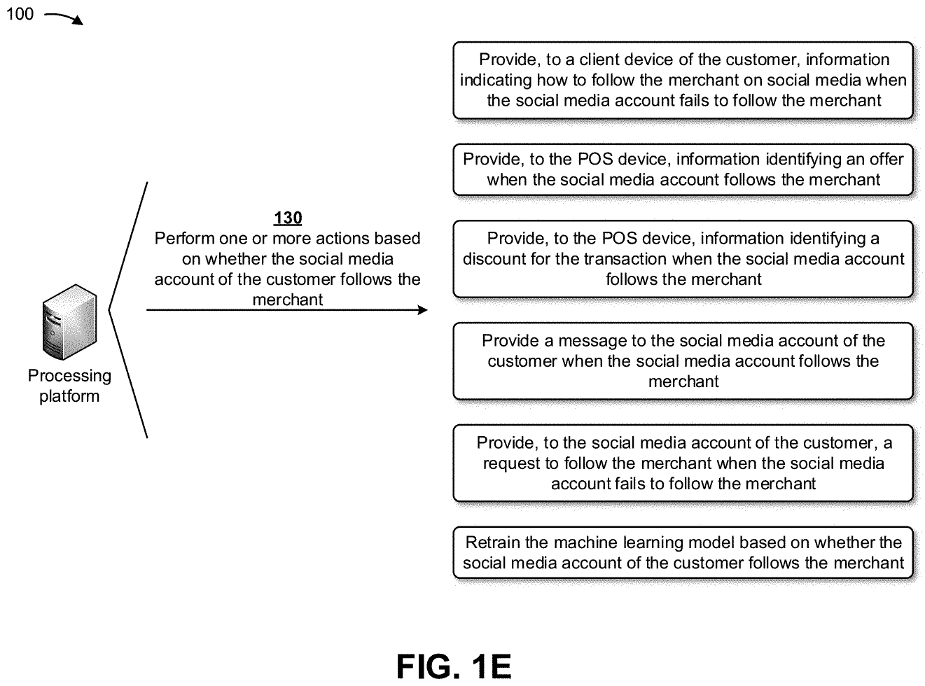

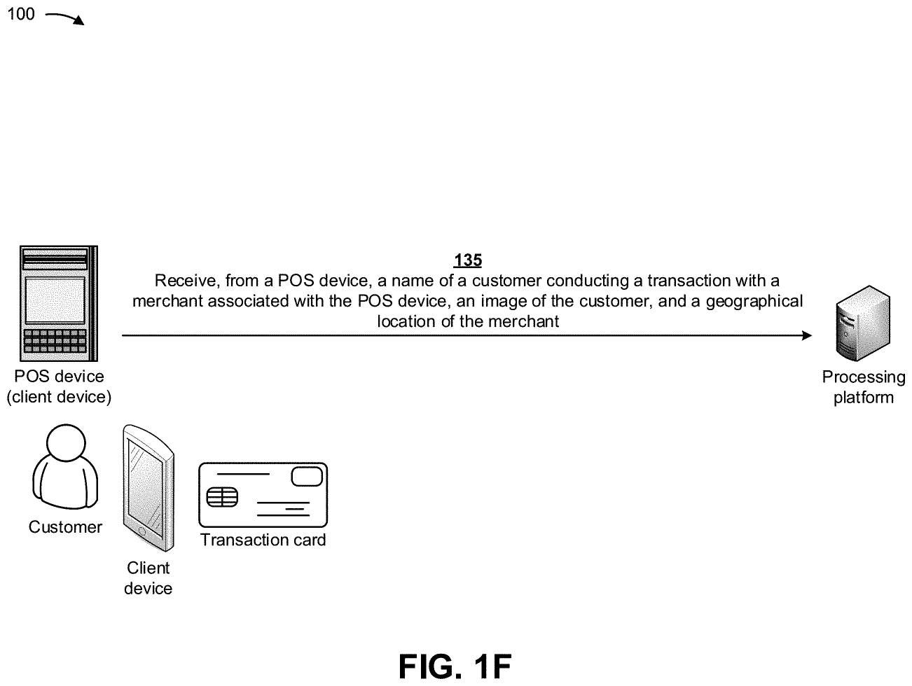

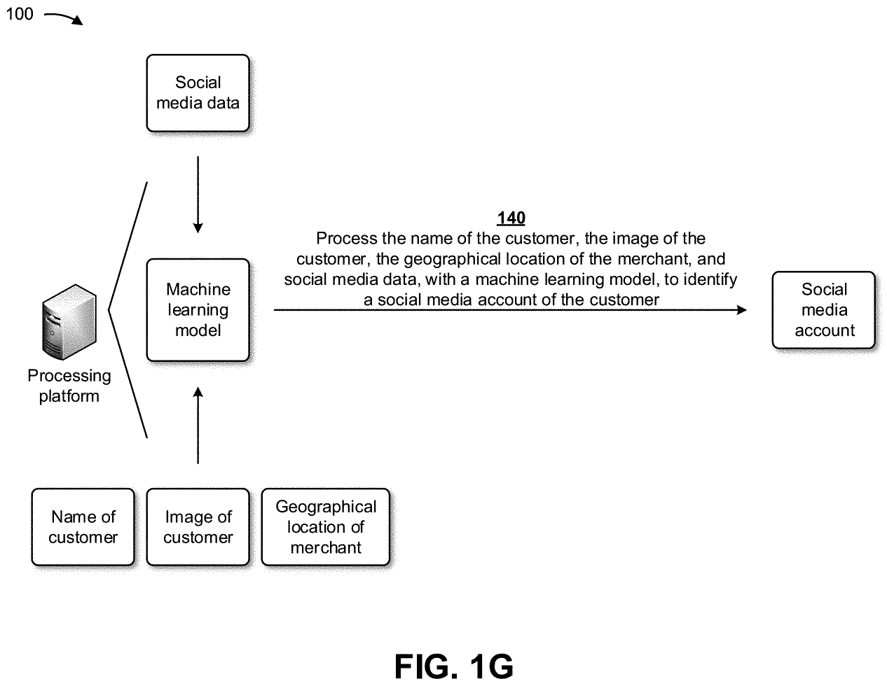

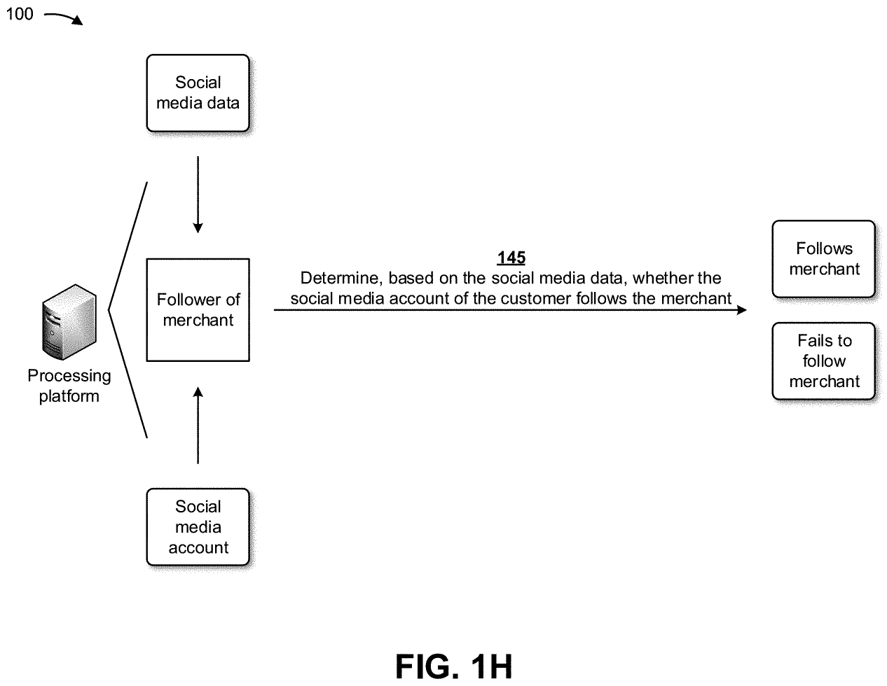

FIGS. 1A-1H are diagrams of one or more example implementations 100 described herein. As shown in FIG. 1A, a point-of-sale (POS) device (e.g., a client device) may be associated with another client device, a transaction card, and a processing platform. The client devices may include mobile devices, computers, POS devices, and/or the like associated with a merchant and/or a customer. The transaction card may include a credit card, a debit card, a gift card, a payment card, an ATM card, and/or the like that may be used to complete a transaction. The processing platform may include a platform that utilizes machine learning to determine whether an in-person customer follows a merchant on social media, as described herein.

As further shown in FIG. 1A, and by reference number 105, the processing platform may receive, from a POS device, transaction data associated with a transaction between a customer and a merchant associated with the POS device. The transaction data may include various information about the customer, payment information associated with the customer, and/or the like. For example, the transaction data may include the customer's bank information, account information, credit card information, and/or the like. This may include a card identifier (e.g., credit card number, debit card number, and/or the like) associated with the customer, a bank associated with the customer, and/or the like.

In some implementations, there may be hundreds, thousands, and/or the like, of client devices that produce thousands, millions, billions, and/or the like, of data points of transaction data and/or customer data. In this way, the processing platform may handle thousands, millions, billions, and/or the like, of data points within a period of time (e.g., daily, weekly, monthly), and thus may provide “big data” capability.

As further shown in FIG. 1A, and by reference number 110, the processing platform may receive customer data from a data structure (e.g., a database, a table, a list, and/or the like). Customer data may include various information that identifies the customer. For example, customer data may include a name associated with the customer, an identifier of the customer, a location associated with the customer, a customer account associated with the merchant (e.g., a customer account, a customer rewards account, and/or the like).

As shown in FIG. 1B, and by reference number 115, the processing platform may determine a customer email address of the customer and other data associated with the transaction, the customer, and/or the merchant, based on the transaction data and the customer data. For example, the processing platform may interact with a server device of a bank, a financial institution, the merchant, and/or the like, to determine a customer email address associated with a credit card, bank account, customer account, and/or the like associated with the transaction. In some implementations, the processing platform may determine other data associated with the transaction, the customer, and/or the merchant. For example, the processing platform may determine a name, a location of the merchant, a location associated with the customer, an age associated with the customer, a common age group associated with the merchant's clientele, and/or the like. In this way, the processing platform may obtain different metrics that may help identify a customer or distinguish a customer from other customers with similar names or other information. For example, an age of the customer, a location of the customer, and/or the like may distinguish the customer from other customers with similar names.

As shown in FIG. 1C, and by reference number 120, the processing platform may process the customer email address, the other data, and social media data, with a machine learning model, to identify a social media account of the customer. The social media data may include various information associated with social media platforms (e.g., a list of accounts associated with the social media platforms, a list of followers associated with an account on the social media platform, and/or the like). For example, the social media data may include information identifying personal accounts (e.g., accounts designed for personal use), business accounts (e.g., accounts designed to represent a business, a merchant, and/or the like), and/or the like. In some implementations, the social media data includes information about a social media account, such as a username associated with the social media account, a picture associated with the social media account, a birthdate of a user of the social media account, an email address associated with the social media account, a location associated with the social media account, and/or the like.

The processing platform may obtain the social media data by scraping a social media website for the social media data, sending a request to a social media platform for the social media data, and/or the like. For example, the processing platform may obtain the social media data by scraping a social media website for publicly available social media data. Additionally, or alternatively, the processing platform may query a social media server for information about social media accounts, perform a search on a social media website, and/or the like. Because a user of a social media platform has full control of what social media data is shared publicly, the processing platform may obtain various amounts of social media data for social media accounts. As one example, the processing platform may obtain, as the social media data, only a name of an owner of a particular social media account. As another example, the processing platform may obtain, as the social media data, a name, a location, a birthdate, a picture, an email address, and/or the like of an owner of another particular social media account. The processing platform may aggregate and store the social media data associated with a plurality of social media accounts associated with one or more social media platforms.

In some implementations, the processing platform may obtain social media data from another device that obtains social media data associated with a plurality of social media accounts associated with one or more social media platforms. For example, the processing platform may obtain social media data from another device, such as a device associated with the merchant that stores social media data associated with a social media account of the merchant. As another example, the processing platform may obtain social media data from a server device that obtains the social media data from a social media platform (e.g., a third party server device that collects data on followers of a social media account, data on social media accounts, and/or the like).

In some implementations, the processing platform may use various information (e.g., the customer email address, the other data, the social media data, and/or the like) to determine potential social media accounts that may be associated with the customer. For example, the processing platform may identify potential social media accounts by searching social media data using the name of the customer, the geographical location of the merchant, and/or the like. Potential social media accounts may have differing amounts of social media data available to help identify a user associated with the social media account. For example, a first potential social media account may have a large amount of social media data available (e.g., social media data indicating an email address associated with the first potential social media account, a first and last name associated with the first potential social media account, and a location associated with the first social media account). In contrast, a second potential social media account may only have social media data available indicating a first name and last initial associated with the second potential social media account. The processing platform may use machine learning with the various information (the customer email address, the other data, and the social media data) to distinguish which potential social media account is likely to be the social media account of the customer based on differing amounts of social media data available.

The processing platform may use machine learning to identify a likelihood that a social media account is associated with the customer. For example, the processing platform may determine a score that indicates the likelihood that a potential social media account is associated with the customer. In some implementations, the processing platform may determine a score for each of a plurality of potential social media accounts that may be associated with the customer.

In some implementations, the processing platform may train the machine learning model with historical input data (e.g., historical transaction data, customer data, names of customers, geographical locations of merchants, and/or the like) and historical output data (e.g., social media accounts associated with customers) to generate a trained machine learning model. The processing platform may be trained to identify weights to be assigned to different types of data (e.g., historical transaction data, customer data, names of customer, geographical locations of merchants, social media data, and/or the like). The weights may be used to identify particular types of data as being more important in a matching operation than other types of data. For example, the processing platform may determine to assign a high weight to the customer email address, such that if the customer email address matches social media data on a potential social media account, then the customer email address is a likely indicator that the potential social media account is the social media account of the customer. In another example, the processing platform may assign a low weight to a customer name, such that if the customer name matches social media data on a potential social media account, the matching customer name is not a likely indicator that the potential social media account is the social media account of the customer. This may be the result of multiple different social media accounts being associated with the customer name, the customer using a different name on the social media account associated with the customer, the customer hiding the name on the social media account associated with the customer, and/or the like.

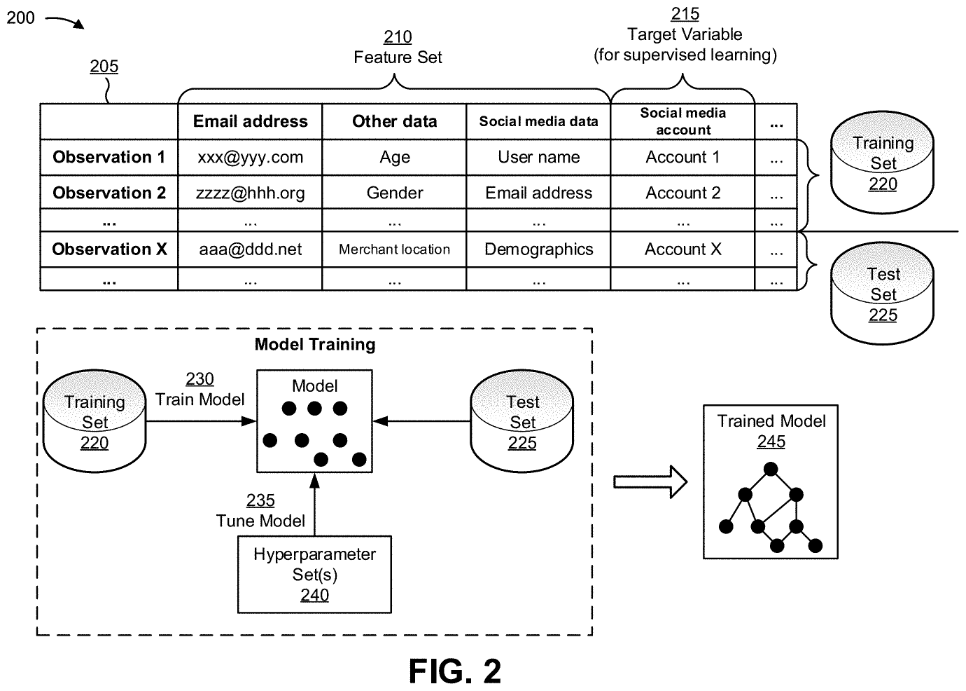

The processing platform may train the machine learning model in a manner similar to the manner described below in connection with FIG. 2. In some implementations, rather than training the machine learning model, the processing platform may obtain the machine learning model from another system or device that trained the machine learning model. In this case, the processing platform may provide the other system or device with historical data for use in training the machine learning model, and may provide the other system or device with updated historical data to retrain the machine learning model in order to update the machine learning model.

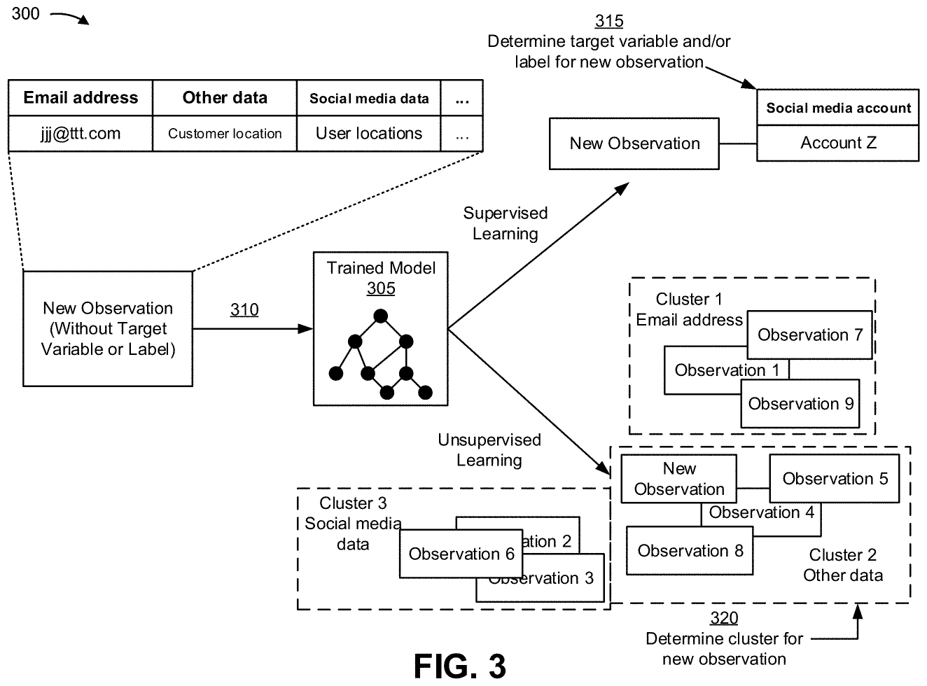

In some implementations, the processing platform may apply the machine learning model to a new observation (e.g., new customer data, transaction data, and/or the like) in a manner similar to the manner described below in connection with FIG. 3 to identify a social media account of the customer. For example, the processing platform may analyze the customer email address, the customer name, the geographical location of the customer, and/or the like to determine which is most important in identifying the social media account of the customer. In this way, the processing platform may identify an unknown social media account of the customer based off the training applied to the machine learning model described above.

As shown in FIG. 1D, and by reference number 125, the processing platform may determine, based on the social media data, whether the social media account of the customer follows the merchant. In some implementations, the processing platform may determine, through resources associated with a social media account of the merchant, whether the social media account of the customer follows the social media account of the merchant (hereinafter “follows the merchant” is intended to mean follows the social media account of the merchant or that the customer and the merchant have a connection on social media, such as a like, a friend, a subscribe, and/or the like). For example, the social media account of the merchant may have information identifying followers of the merchant, information identifying users who have interacted with the merchant (e.g., left a review on a social media account of the merchant, commented on a merchant's post on a social media account, liked a merchant's post, and/or the like), and/or the like. In some implementations, the processing platform may determine, through information provided by the merchant, whether the social media account of the customer follows the merchant. In some implementations, the processing platform may determine, through resources associated with a social media account of the customer, whether the social media account of the customer follows the merchant. For example, the social media platform may be able to determine that the social media account of the customer follows the merchant if the social media account of the customer is public, publicly lists information that indicates that the social media account of the customer follows the merchant, and/or the like. In some implementations, based on not finding information associating the social media account of the customer with the social media account of the merchant, the processing platform may determine that the social media account of the customer does not follow the social media account of the merchant.

As shown in FIG. 1E, and by reference number 130, the processing platform may perform one or more actions based on whether the social media account of the customer follows the merchant. In some implementations, the processing platform may perform one or more actions based on determining that the social media account of the customer does not follow the merchant. For example, the processing platform may provide information designed to encourage the customer to follow the merchant on social media, such as providing, to a client device of the customer, information indicating how to follow the merchant on social media. In some implementations, the processing platform may provide, to the POS device, information identifying an offer when the social media account of the customer follows the merchant, information identifying a discount for the transaction when the social media account of the customer follows the merchant, and/or the like. In some implementations, the processing platform may provide, to the social media account of the customer, a request to follow the merchant when the social media account does not follow the merchant.

In some implementations, the one or more actions may include the processing platform providing, to the client device, instructions for performing the particular action. For example, the processing platform may provide the instructions to the client device, and the client device may display the instructions to the user. In this way, the processing platform may enable the user to receive instructions for performing the particular action, thereby conserving computing resources (e.g., processing resources, memory resources, communication resources, and/or the like), networking resources, and/or the like that would have otherwise been wasted by the user in attempting to determine the particular action.

In some implementations, the processing platform may perform one or more actions based on determining that the social media account of the customer follows the merchant. In some implementations, the processing platform may perform one or more actions based on determining that the social media account of the customer, after originally not having followed the merchant, has changed status to following the merchant. For example, the processing platform may provide a message to the social media account of the customer when the social media account of the customer follows the merchant. Additionally, or alternatively, the processing platform may provide a specialized message with offers, discounts, and/or the like to the customer when the social media account of the customer follows the merchant.

In some implementations, the processing platform may retrain the machine learning model based on whether the social media account of the customer follows the merchant. For example, the one or more actions may include the processing platform retraining the machine learning model based on the particular action and/or feedback associated with performance of the particular action. In this way, the processing platform may improve the accuracy of the machine learning model, which may improve speed and efficiency of the machine learning model and conserve computing resources, networking resources, and/or the like.

FIGS. 1F-1H related to a different example. As shown in FIG. 1F, and by reference number 135, the processing platform may receive, from a POS device, a name of a customer conducting a transaction with a merchant associated with the POS device, an image of the customer, and a geographical location of the merchant. In some implementations, the processing platform may obtain the name of the customer from a payment card that the customer uses to conduct the transaction. For example, the processing platform, the POS device, and/or the like may obtain the customer's name from a magstripe, a chip, and/or the like of the payment card to obtain the name of the customer. In some implementations, the processing platform may obtain the image of the customer from a camera used to capture an image associated with the customer. For example, an integrated camera with the POS device may be used to capture an image of the customer. In some implementations, external cameras, such as security cameras, may be used to capture an image of the customer. Additional processing may be performed to associate the image of the customer with the transaction. For example, a time of the transaction may be used with a time associated with the image of the customer conducting a transaction to associate the image of the customer with the transaction, image recognition technology may be used to associate the image of the customer with a name of the customer, and/or the like.

As shown in FIG. 1G, and by reference number 140, the processing platform may process the name of the customer, the image of the customer, the geographical location of the merchant, and social media data, with a machine learning model, to identify a social media account of the customer. For example, the processing platform may perform a search of a social media account using the name of the customer, the image of the customer, the geographical location of the merchant, and/or the like to obtain a list of potential social media accounts, and determine which of the potential social media accounts is the social media account of the customer. In some implementations, the processing platform may perform an image search of publicly available images, images that were consented to being released, and/or the like to identify an image similar to the image of the customer. Similar to FIG. 1C, the processing platform may use machine learning to identify which information (e.g., the name of the customer, the image of the customer, the geographic location of the merchant, and/or the like) is most likely to indicate an accurate social media account linked to the customer, which of the information is most useful in applying to a search for the social media account of the customer, which of the various information (if matching information present on a potential social media account) is likely to indicate that the potential social media account is the social media account of the customer, and/or the like.

In some implementations, the processing platform may train the machine learning model with historical data (e.g., historical transaction data, customer data, images of customers, names of customers, geographical locations of merchants, and/or the like) to generate a machine learning model that is trained to identify a social media account of a customer, in a manner similar to that described above with regard to FIG. 1C. In some implementations, the processing platform may train the machine learning model in a manner similar to the manner described below in connection with FIG. 2. In some implementations, rather than training the machine learning model, the processing platform may obtain the machine learning model from another system or device that trained the machine learning model. In this case, the processing platform may provide the other system or device with historical data for use in training the machine learning model, and may provide the other system or device with updated historical data to retrain the machine learning model in order to update the machine learning model.

In some implementations, the processing platform may apply the machine learning model to a new observation in a manner similar to the manner described below in connection with FIG. 3 to identify the social media account of the customer. Based on this, the processing platform may identify an unknown social media account of the customer using the trained machine learning model. In this way, the processing platform may identify an unknown social media account of the customer based on the training applied to the machine learning model.

As shown in FIG. 1H, and by reference number 145, the processing platform may determine, based on the social media data, whether the social media account of the customer follows the merchant. The processing platform may determine that the social media account of the customer follows the merchant in a similar way to what was described above in relation to FIG. 1D. For example, the processing platform may determine, through resources associated with a social media account of the merchant, whether the social media account of the customer follows the merchant. The social media account of the merchant may have information identifying followers of the merchant, information identifying users who have interacted with the merchant (e.g., left a review on a social media account of the merchant, commented on a merchant's post on a social media account, liked a merchants post, and/or the like), and/or the like. In some implementations, the processing platform may determine, through information provided by the merchant, whether the social media account of the customer follows the merchant. Additionally, or alternatively, the processing platform may determine, through resources associated with a social media account of the customer, whether the social media account of the customer follows the merchant. In some implementations, based on not finding information associating the social media account of the customer with the social media account of the merchant, the processing platform may determine that the social media account of the customer does not follow the social media account of the merchant.

The processing platform may perform one or more actions based on whether the social media account of the customer follows the merchant. Examples of the one or more actions are provided above with regard to FIG. 1E.

In this way, several different stages of the process for determining whether an in-person customer follows a merchant on social media are automated via machine learning, which may remove human subjectivity and waste from the process, and which may improve speed and efficiency of the process and conserve computing resources (e.g., processing resources, memory resources, communication resources, and/or the like), networking resources, and/or the like. Furthermore, implementations described herein use a rigorous, computerized process to perform tasks or roles that were not previously performed or were previously performed using subjective human intuition or input. For example, currently there does not exist a technique that utilizes machine learning to determine whether an in-person customer follows a merchant on social media in the manner described herein. Finally, the process for utilizing machine learning to determine whether an in-person customer follows a merchant on social media conserves computing resources, networking resources, and/or the like that would otherwise have been wasted in attempting to accurately provide social media marketing to customers of a merchant, incorrectly identifying social media accounts of the customers, correcting the incorrect identification of the social media accounts if discovered, and/or like.

As indicated above, FIGS. 1A-1H are provided merely as examples. Other examples may differ from what is described with regard to FIGS. 1A-1H.

FIG. 2 is a diagram illustrating an example 200 of training a machine learning model. The machine learning model training described herein may be performed using a machine learning system. The machine learning system may include a computing device, a server, a cloud computing environment, and/or the like, such as the client device and/or the processing platform, and/or a device separate from the client device and/or the processing platform.

As shown by reference number 205, a machine learning model may be trained using a set of observations. The set of observations may be obtained and/or input from historical data, such as data gathered during one or more processes described herein. For example, the set of observations may include data gathered from user interaction with and/or user input to the processing platform, as described elsewhere herein. In some implementations, the machine learning system may receive the set of observations (e.g., as input) from the client device.

As shown by reference number 210, a feature set may be derived from the set of observations. The feature set may include a set of variable types. A variable type may be referred to as a feature. A specific observation may include a set of variable values corresponding to the set of variable types. A set of variable values may be specific to an observation. In some cases, different observations may be associated with different sets of variable values, sometimes referred to as feature values. In some implementations, the machine learning system may determine variable values for a specific observation based on input received from the client device. For example, the machine learning system may identify a feature set (e.g., one or more features and/or corresponding feature values) from structured data input to the machine learning system, such as by extracting data from a particular column of a table, extracting data from a particular field of a form, extracting data from a particular field of a message, extracting data received in a structured data format, and/or the like. In some implementations, the machine learning system may determine features (e.g., variables types) for a feature set based on input received from the client device, such as by extracting or generating a name for a column, extracting or generating a name for a field of a form and/or a message, extracting or generating a name based on a structured data format, and/or the like. Additionally, or alternatively, the machine learning system may receive input from an operator to determine features and/or feature values. In some implementations, the machine learning system may perform natural language processing and/or another feature identification technique to extract features (e.g., variable types) and/or feature values (e.g., variable values) from text (e.g., unstructured data) input to the machine learning system, such as by identifying keywords and/or values associated with those keywords from the text.

As an example, a feature set for a set of observations may include a first feature of an email address, a second feature of other data, a third feature of social media data, and so on. As shown, for a first observation, the first feature may have a value of xxx@yyy.com, the second feature may have an age of a customer, the third feature may have a user name on social medial, and so on. These features and feature values are provided as examples, and may differ in other examples. For example, the feature set may include one or more of the following features: email addresses (e.g., email addresses associated with social media accounts); other data (e.g., names of customers, locations of merchants, locations of customers, ages of customers, sexes of customers, demographics of customers, and/or the like); social media data (e.g., user names, email addresses, demographics, and/or the like); and/or the like. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources, memory resources, and/or the like) used to train the machine learning model.

As shown by reference number 215, the set of observations may be associated with a target variable type (e.g., a social media account). The target variable type may represent a variable having a numeric value (e.g., an integer value, a floating point value, and/or the like), may represent a variable having a numeric value that falls within a range of values or has some discrete possible values, may represent a variable that is selectable from one of multiple options (e.g., one of multiples classes, classifications, labels, and/or the like), may represent a variable having a Boolean value (e.g., 0 or 1, True or False, Yes or No), and/or the like. A target variable type may be associated with a target variable value, and a target variable value may be specific to an observation. In some cases, different observations (e.g., different words, phrases, sentences, and/or the like) may be associated with different target variable values.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model, a predictive model, and/or the like. When the target variable type is associated with continuous target variable values (e.g., a range of numbers and/or the like), the machine learning model may employ a regression technique. When the target variable type is associated with categorical target variable values (e.g., classes, labels, and/or the like), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, an automated signal extraction model, and/or the like. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that includes a first subset of observations, of the set of observations, and a test set 225 that includes a second subset of observations of the set of observations. The training set 220 may be used to train (e.g., fit, tune, and/or the like) the machine learning model, while the test set 225 may be used to evaluate a machine learning model that is trained using the training set 220. For example, for supervised learning, the test set 225 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 15%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression, logistic regression, and/or the like), which may include a regularized regression algorithm (e.g., Lasso regression, Ridge regression, Elastic-Net regression, and/or the like). Additionally, or alternatively, the machine learning algorithm may include a decision tree algorithm, which may include a tree ensemble algorithm (e.g., generated using bagging and/or boosting), a random forest algorithm, a boosted trees algorithm, and/or the like. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), may be applied by setting one or more feature values to zero (e.g., for automatic feature selection), and/or the like. Example hyperparameters for a decision tree algorithm include a tree ensemble technique to be applied (e.g., bagging, boosting, a random forest algorithm, a boosted trees algorithm, and/or the like), a number of features to evaluate, a number of observations to use, a maximum depth of each decision tree (e.g., a number of branches permitted for the decision tree), a number of decision trees to include in a random forest algorithm, and/or the like.

To train a machine learning model, the machine learning system may identify a set of machine learning algorithms to be trained (e.g., based on operator input that identifies the one or more machine learning algorithms, based on random selection of a set of machine learning algorithms, and/or the like), and may train the set of machine learning algorithms (e.g., independently for each machine learning algorithm in the set) using the training set 220. The machine learning system may tune each machine learning algorithm using one or more hyperparameter sets 240 (e.g., based on operator input that identifies hyperparameter sets 240 to be used, based on randomly generating hyperparameter values, and/or the like). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross validation can be used to obtain a reliable estimate of machine learning model performance using only the training set 220, and without using the test set 225, such as by splitting the training set 220 into a number of groups (e.g., based on operator input that identifies the number of groups, based on randomly selecting a number of groups, and/or the like) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, a standard error across cross-validation scores, and/or the like.

In some implementations, the machine learning system may perform cross-validation when training a machine learning model by splitting the training set into a number of groups (e.g., based on operator input that identifies the number of groups, based on randomly selecting a number of groups, and/or the like). The machine learning system may perform multiple training procedures and may generate a cross-validation score for each training procedure. The machine learning system may generate an overall cross-validation score for each hyperparameter set 240 associated with a particular machine learning algorithm. The machine learning system may compare the overall cross-validation scores for different hyperparameter sets 240 associated with the particular machine learning algorithm, and may select the hyperparameter set 240 with the best (e.g., highest accuracy, lowest error, closest to a desired threshold, and/or the like) overall cross-validation score for training the machine learning model. The machine learning system may then train the machine learning model using the selected hyperparameter set 240, without cross-validation (e.g., using all data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), an area under receiver operating characteristic curve (e.g., for classification), and/or the like. If the machine learning model performs adequately (e.g., with a performance score that satisfies a threshold), then the machine learning system may store that machine learning model as a trained machine learning model 245 to be used to analyze new observations, as described below in connection with FIG. 3.

In some implementations, the machine learning system may perform cross-validation, as described above, for multiple machine learning algorithms (e.g., independently), such as a regularized regression algorithm, different types of regularized regression algorithms, a decision tree algorithm, different types of decision tree algorithms, and/or the like. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 220 (e.g., without cross-validation), and may test each machine learning model using the test set 225 to generate a corresponding performance score for each machine learning model. The machine learning model may compare the performance scores for each machine learning model, and may select the machine learning model with the best (e.g., highest accuracy, lowest error, closest to a desired threshold, and/or the like) performance score as the trained machine learning model 245.

As indicated above, FIG. 2 is provided as an example. Other examples may differ from what is described in connection with FIG. 2. For example, the machine learning model may be trained using a different process than what is described in connection with FIG. 2. Additionally, or alternatively, the machine learning model may employ a different machine learning algorithm than what is described in connection with FIG. 2, such as a Bayesian estimation algorithm, a k-nearest neighbor algorithm, an a priori algorithm, a k-means algorithm, a support vector machine algorithm, a neural network algorithm (e.g., a convolutional neural network algorithm), a deep learning algorithm, and/or the like.

FIG. 3 is a diagram illustrating an example 300 of applying a trained machine learning model to a new observation. The new observation may be input to a machine learning system that stores a trained machine learning model 305. In some implementations, the trained machine learning model 305 may be the trained machine learning model 245 described above in connection with FIG. 2. The machine learning system may include a computing device, a server, a cloud computing environment, and/or the like, such as the processing platform.

As shown by reference number 310, the machine learning system may receive a new observation (or a set of new observations), and may input the new observation to the machine learning model 305. As shown, the new observation may include a first feature of an email address (e.g., jjj@ttt.com), a second feature of other data (e.g., a customer location), a third feature of social media data (e.g., user locations), and so on, as an example. The machine learning system may apply the trained machine learning model 305 to the new observation to generate an output (e.g., a result). The type of output may depend on the type of machine learning model and/or the type of machine learning task being performed. For example, the output may include a predicted (e.g., estimated) value of a target variable (e.g., a value within a continuous range of values, a discrete value, a label, a class, a classification, and/or the like), such as when supervised learning is employed. Additionally, or alternatively, the output may include information that identifies a cluster to which the new observation belongs, information that indicates a degree of similarity between the new observations and one or more prior observations (e.g., which may have previously been new observations input to the machine learning model and/or observations used to train the machine learning model), and/or the like, such as when unsupervised learning is employed.

In some implementations, the trained machine learning model 305 may predict “Account Z” for the target variable of a social media account, as shown by reference number 315. Based on this prediction (e.g., based on the value having a particular label/classification, based on the value satisfying or failing to satisfy a threshold, and/or the like), the machine learning system may provide a recommendation, such as the customer is associated with Account Z. Additionally, or alternatively, the machine learning system may perform an automated action and/or may cause an automated action to be performed (e.g., by instructing another device to perform the automated action), such as determining whether Account Z follows the merchant on social media. As another example, if the machine learning system were to predict a value of “Account W” for the target variable of strings of characters, then the machine learning system may provide a different recommendation (e.g., the customer is associated with Account W) and/or may perform or cause performance of a different automated action (e.g., determining whether Account W follows the merchant on social media). In some implementations, the recommendation and/or the automated action may be based on the target variable value having a particular label (e.g., classification, categorization, and/or the like), may be based on whether the target variable value satisfies one or more thresholds (e.g., whether the target variable value is greater than a threshold, is less than a threshold, is equal to a threshold, falls within a range of threshold values, and/or the like), and/or the like.

In some implementations, the trained machine learning model 305 may classify (e.g., cluster) the new observation in an email address cluster, as shown by reference number 320. The observations within a cluster may have a threshold degree of similarity. Based on classifying the new observation in the email address cluster, the machine learning system may provide a recommendation, such as the email address may be used to determine a social media account of the customer. Additionally, or alternatively, the machine learning system may perform an automated action and/or may cause an automated action to be performed (e.g., by instructing another device to perform the automated action), such as using the email address to determine a social media account of the customer. As another example, if the machine learning system were to classify the new observation in other data cluster, then the machine learning system may provide a different recommendation (e.g., a name of the customer may be used to determine a social media account of the customer) and/or may perform or cause performance of a different automated action (e.g., using a name of the customer to determine a social media account of the customer). As still another example, if the machine learning system were to classify the new observation in social media data cluster, then the machine learning system may provide a different recommendation (e.g., a location of a social media user may be used to determine a social media account of the customer) and/or may perform or cause performance of a different automated action (e.g., using a location of a social media user to determine a social media account of the customer).

In this way, the machine learning system may apply a rigorous and automated process to process image-based documents. The machine learning system enables recognition and/or identification of tens, hundreds, thousands, or millions of features and/or feature values for tens, hundreds, thousands, or millions of observations, thereby increasing an accuracy and consistency of processing image-based documents relative to requiring computing resources to be allocated for tens, hundreds, or thousands of operators to manually process image-based documents.

As indicated above, FIG. 3 is provided as an example. Other examples may differ from what is described in connection with FIG. 3.

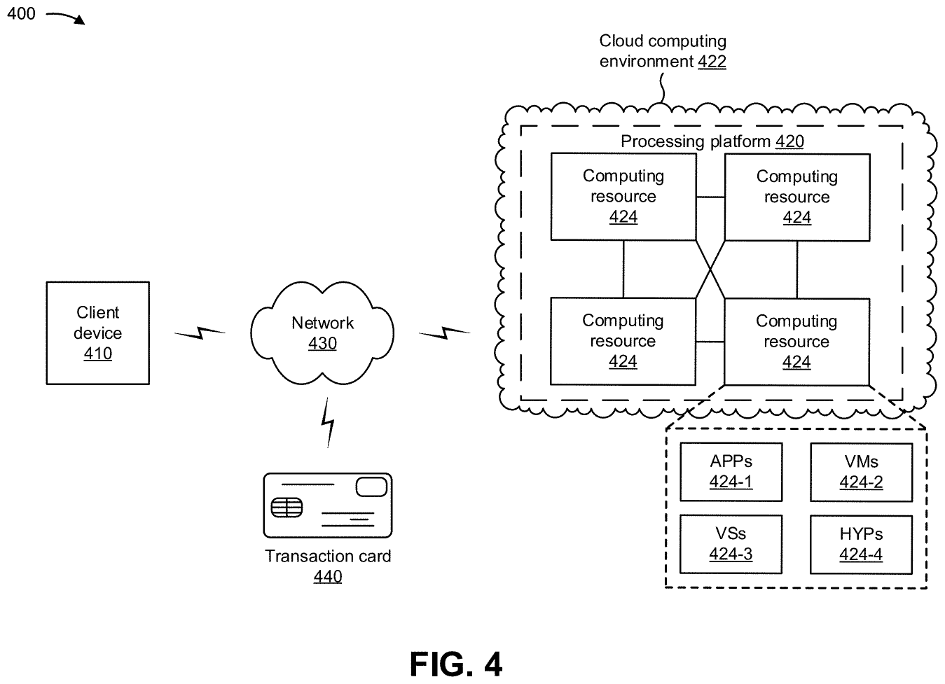

FIG. 4 is a diagram of an example environment 400 in which systems and/or methods described herein may be implemented. As shown in FIG. 4, environment 400 may include a client device 410, a processing platform 420, a network 430, and a transaction card 440. Devices of environment 400 may interconnect via wired connections, wireless connections, or a combination of wired and wireless connections.

Client device 410 includes one or more devices capable of receiving, generating, storing, processing, and/or providing information, such as information described herein. For example, client device 410 may include a mobile phone (e.g., a smart phone, a radiotelephone, and/or the like), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, a head mounted display, and/or the like), a POS device, or a similar type of device. In some implementations, client device 410 may receive information from and/or transmit information to processing platform 420.

Processing platform 420 includes one or more devices that utilize machine learning to determine whether an in-person customer follows a merchant on social media. In some implementations, processing platform 420 may be designed to be modular such that certain software components may be swapped in or out depending on a particular need. As such, processing platform 420 may be easily and/or quickly reconfigured for different uses. In some implementations, processing platform 420 may receive information from and/or transmit information to one or more client devices 410.

In some implementations, as shown, processing platform 420 may be hosted in a cloud computing environment 422. Notably, while implementations described herein describe processing platform 420 as being hosted in cloud computing environment 422, in some implementations, processing platform 420 may not be cloud-based (i.e., may be implemented outside of a cloud computing environment) or may be partially cloud-based.

Cloud computing environment 422 includes an environment that hosts processing platform 420. Cloud computing environment 422 may provide computation, software, data access, storage, etc., services that do not require end-user knowledge of a physical location and configuration of system(s) and/or device(s) that hosts processing platform 420. As shown, cloud computing environment 422 may include a group of computing resources 424 (referred to collectively as “computing resources 424” and individually as “computing resource 424”).

Computing resource 424 includes one or more personal computers, workstation computers, mainframe devices, or other types of computation and/or communication devices. In some implementations, computing resource 424 may host processing platform 420. The cloud resources may include compute instances executing in computing resource 424, storage devices provided in computing resource 424, data transfer devices provided by computing resource 424, etc. In some implementations, computing resource 424 may communicate with other computing resources 424 via wired connections, wireless connections, or a combination of wired and wireless connections.

As further shown in FIG. 4, computing resource 424 includes a group of cloud resources, such as one or more applications (“APPs”) 424-1, one or more virtual machines (“VMs”) 424-2, virtualized storage (“VSs”) 424-3, one or more hypervisors (“HYPs”) 424-4, and/or the like.

Application 424-1 includes one or more software applications that may be provided to or accessed by client device 410. Application 424-1 may eliminate a need to install and execute the software applications on client device 410. For example, application 424-1 may include software associated with processing platform 420 and/or any other software capable of being provided via cloud computing environment 422. In some implementations, one application 424-1 may send/receive information to/from one or more other applications 424-1, via virtual machine 424-2.

Virtual machine 424-2 includes a software implementation of a machine (e.g., a computer) that executes programs like a physical machine. Virtual machine 424-2 may be either a system virtual machine or a process virtual machine, depending upon use and degree of correspondence to any real machine by virtual machine 424-2. A system virtual machine may provide a complete system platform that supports execution of a complete operating system (“OS”). A process virtual machine may execute a single program and may support a single process. In some implementations, virtual machine 424-2 may execute on behalf of a user (e.g., a user of client device 410 or an operator of processing platform 420), and may manage infrastructure of cloud computing environment 422, such as data management, synchronization, or long-duration data transfers.

Virtualized storage 424-3 includes one or more storage systems and/or one or more devices that use virtualization techniques within the storage systems or devices of computing resource 424. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 424-4 may provide hardware virtualization techniques that allow multiple operating systems (e.g., “guest operating systems”) to execute concurrently on a host computer, such as computing resource 424. Hypervisor 424-4 may present a virtual operating platform to the guest operating systems and may manage the execution of the guest operating systems. Multiple instances of a variety of operating systems may share virtualized hardware resources.

Network 430 includes one or more wired and/or wireless networks. For example, network 430 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

Transaction card 440 includes a transaction card that can be used to complete a transaction. For example, transaction card 440 may include a credit card, a debit card, a gift card, a payment card, an automated teller machine (ATM) card, a stored-value card, a fleet card, a room or building access card, a driver's license card, and/or the like. Transaction card 440 may be capable of storing and/or communicating data for a POS transaction with a transaction terminal. For example, transaction card 440 may store and/or communicate data, including account information (e.g., an account identifier, a cardholder identifier, etc.), expiration information of transaction card 440 (e.g., information identifying an expiration month and/or year of transaction card 440), banking information (e.g., a routing number of a bank, a bank identifier, etc.), transaction information (e.g., a payment token), and/or the like. For example, to store and/or communicate the data, transaction card 440 may include a magnetic strip and/or an integrated circuit (IC) chip.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

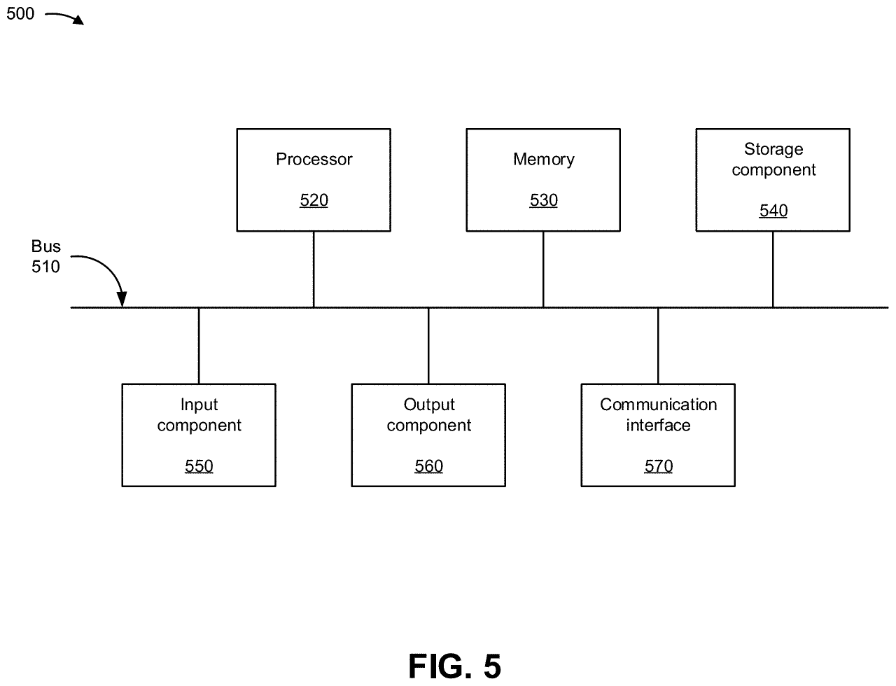

FIG. 5 is a diagram of example components of a device 500. Device 500 may correspond to client device 410, processing platform 420, computing resource 424, and/or transaction card 440. In some implementations, client device 410, processing platform 420, computing resource 424, and/or transaction card 440 may include one or more devices 500 and/or one or more components of device 500. As shown in FIG. 5, device 500 may include a bus 510, a processor 520, a memory 530, a storage component 540, an input component 550, an output component 560, and a communication interface 570.

Bus 510 includes a component that permits communication among the components of device 500. Processor 520 is implemented in hardware, firmware, or a combination of hardware and software. Processor 520 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random-access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 550 includes a component that permits device 500 to receive information, such as via user input (e.g., a touch screen display, a keyboard, a keypad, a mouse, a button, a switch, and/or a microphone). Additionally, or alternatively, input component 550 may include a sensor for sensing information (e.g., a global positioning system (GPS) component, an accelerometer, a gyroscope, and/or an actuator). Output component 560 includes a component that provides output information from device 500 (e.g., a display, a speaker, and/or one or more light-emitting diodes (LEDs)).

Communication interface 570 includes a transceiver-like component (e.g., a transceiver and/or a separate receiver and transmitter) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, and/or the like.

Device 500 may perform one or more processes described herein. Device 500 may perform these processes based on processor 520 executing software instructions stored by a non-transitory computer-readable medium, such as memory 530 and/or storage component 540. A computer-readable medium is defined herein as a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

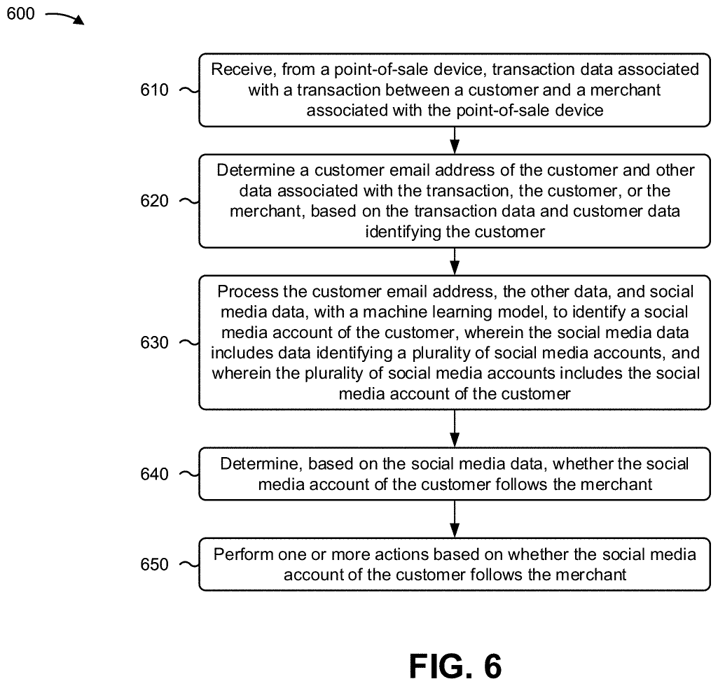

FIG. 6 is a flow chart of an example process 600 for utilizing machine learning to determine whether an in-person customer follows a merchant on social media. In some implementations, one or more process blocks of FIG. 6 may be performed by a device (e.g., processing platform 420). In some implementations, one or more process blocks of FIG. 6 may be performed by another device or a group of devices separate from or including the device, such as a client device (e.g., client device 410).

As shown in FIG. 6, process 600 may include receiving, from a point-of-sale device, transaction data associated with a transaction between a customer and a merchant associated with the point-of-sale device (block 610). For example, the device (e.g., using computing resource 424, processor 520, communication interface 570, and/or the like) may receive, from a point-of-sale device, transaction data associated with a transaction between a customer and a merchant associated with the point-of-sale device, as described above.

As further shown in FIG. 6, process 600 may include determining a customer email address of the customer and other data associated with the transaction, the customer, or the merchant, based on the transaction data and customer data identifying the customer (block 620). For example, the device (e.g., using computing resource 424, processor 520, memory 530, and/or the like) may determine a customer email address of the customer and other data associated with the transaction, the customer, or the merchant, based on the transaction data and customer data identifying the customer, as described above.

As further shown in FIG. 6, process 600 may include processing the customer email address, the other data, and social media data, with a machine learning model, to identify a social media account of the customer, wherein the social media data includes data identifying a plurality of social media accounts, and wherein the plurality of social media accounts includes the social media account of the customer (block 630). For example, the device (e.g., using computing resource 424, processor 520, storage component 540, and/or the like) may process the customer email address, the other data, and social media data, with a machine learning model, to identify a social media account of the customer, as described above. In some implementations, the social media data includes data may identify a plurality of social media accounts. In some implementations, the plurality of social media accounts may include the social media account of the customer.

As further shown in FIG. 6, process 600 may include determining, based on the social media data, whether the social media account of the customer follows the merchant (block 640). For example, the device (e.g., using computing resource 424, processor 520, memory 530, and/or the like) may determine, based on the social media data, whether the social media account of the customer follows the merchant, as described above.

As further shown in FIG. 6, process 600 may include performing one or more actions based on whether the social media account of the customer follows the merchant (block 650). For example, the device (e.g., using computing resource 424, processor 520, memory 530, storage component 540, communication interface 570, and/or the like) may perform one or more actions based on whether the social media account of the customer follows the merchant, as described above.

Process 600 may include additional implementations, such as any single implementation or any combination of implementations described below and/or in connection with one or more other processes described elsewhere herein.

In a first implementation, the other data may include data identifying an identifier of the transaction, a geographical location of the transaction, a name of the customer, a geographical location of the merchant, a geographical location of the customer, an age of the customer, or demographics associated with the customer.

In a second implementation, alone or in combination with the first implementation, process 600 may include performing a sentiment analysis of the customer with the merchant; and performing one or more other actions based on the sentiment analysis.

In a third implementation, alone or in combination with one or more of the first and second implementations, performing the one or more actions based on whether the social media account of the customer follows the merchant may include providing, to a client device of the customer, information indicating how to follow the merchant on social media when the social media account fails to follow the merchant; providing, to the point-of-sale device, information identifying an offer for the customer when the social media account follows the merchant; or providing, to the point-of-sale device, information identifying a discount for the transaction when the social media account follows the merchant.

In a fourth implementation, alone or in combination with one or more of the first through third implementations, performing the one or more actions based on whether the social media account of the customer follows the merchant may include providing a message to the social media account of the customer when the social media account follows the merchant; providing, to the social media account of the customer, a request to follow the merchant when the social media account fails to follow the merchant; or retraining the machine learning model based on whether the social media account of the customer follows the merchant.

In a fifth implementation, alone or in combination with one or more of the first through fourth implementations, determining, based on the social media data, whether the social media account of the customer follows the merchant may include determining, based on the social media data, whether the social media account of the customer follows the merchant, a product of the merchant, or a service of the merchant.

In a sixth implementation, alone or in combination with one or more of the first through fifth implementations, determining, based on the social media data, whether the social media account of the customer follows the merchant may include maintaining a list of social media accounts that follow the merchant; comparing the social media account of the customer to the list of social media accounts that follow the merchant; and determining whether the social media account of the customer follows the merchant based on comparing the social media account of the customer to the list of social media accounts that follow the merchant.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

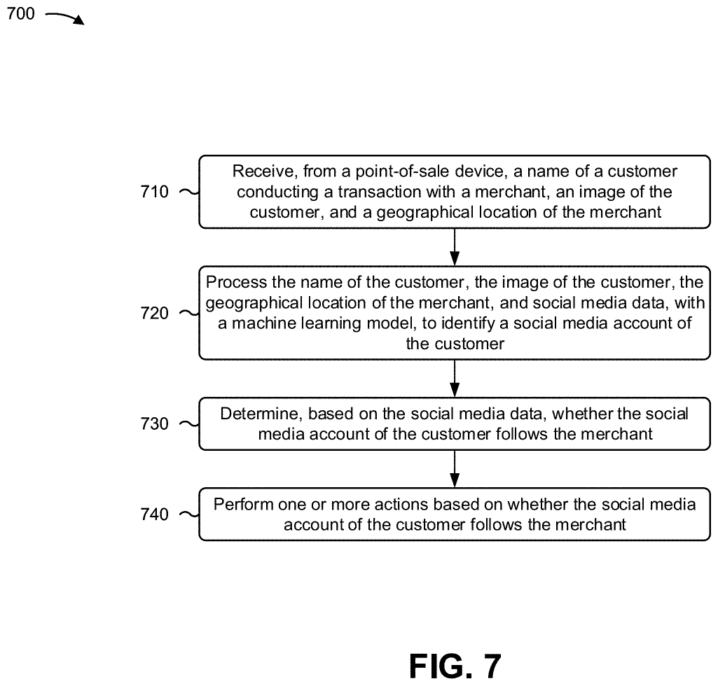

FIG. 7 is a flow chart of an example process 700 for utilizing machine learning to determine whether an in-person customer follows a merchant on social media. In some implementations, one or more process blocks of FIG. 7 may be performed by a device (e.g., processing platform 420). In some implementations, one or more process blocks of FIG. 7 may be performed by another device or a group of devices separate from or including the device, such as a client device (e.g., client device 410).

As shown in FIG. 7, process 700 may include receiving, from a point-of-sale device, a name of a customer conducting a transaction with a merchant, an image of the customer, and a geographical location of the merchant (block 710). For example, the device (e.g., using computing resource 424, processor 520, communication interface 570, and/or the like) may receive, from a point-of-sale device, a name of a customer conducting a transaction with a merchant, an image of the customer, and a geographical location of the merchant, as described above.

As further shown in FIG. 7, process 700 may include processing the name of the customer, the image of the customer, the geographical location of the merchant, and social media data, with a machine learning model, to identify a social media account of the customer (block 720). For example, the device (e.g., using computing resource 424, processor 520, storage component 540, and/or the like) may process the name of the customer, the image of the customer, the geographical location of the merchant, and social media data, with a machine learning model, to identify a social media account of the customer, as described above.

As further shown in FIG. 7, process 700 may include determining, based on the social media data, whether the social media account of the customer follows the merchant (block 730). For example, the device (e.g., using computing resource 424, processor 520, memory 530, and/or the like) may determine, based on the social media data, whether the social media account of the customer follows the merchant, as described above.

As further shown in FIG. 7, process 700 may include performing one or more actions based on whether the social media account of the customer follows the merchant (block 740). For example, the device (e.g., using computing resource 424, processor 520, memory 530, storage component 540, communication interface 570, and/or the like) may perform one or more actions based on whether the social media account of the customer follows the merchant, as described above.

Process 700 may include additional implementations, such as any single implementation or any combination of implementations described below and/or in connection with one or more other processes described elsewhere herein.

In a first implementation, the name of the customer may be received from a transaction card associated with the customer.

In a second implementation, alone or in combination with the first implementation, the image of the customer may be received from a camera associated with the point-of-sale device.

In a third implementation, alone or in combination with one or more of the first and second implementations, the geographical location of the merchant may include a geographical location of the point-of-sale device.

In a fourth implementation, alone or in combination with one or more of the first through third implementations, performing the one or more actions based on whether the social media account of the customer follows the merchant may include providing, to a client device of the customer, information indicating how to follow the merchant on social media when the social media account fails to follow the merchant; providing, to the point-of-sale device, information identifying an offer for the customer when the social media account follows the merchant; or providing, to the point-of-sale device, information identifying a discount for the transaction when the social media account follows the merchant.

In a fifth implementation, alone or in combination with one or more of the first through fourth implementations, performing the one or more actions based on whether the social media account of the customer follows the merchant may include providing a message to the social media account of the customer when the social media account follows the merchant; providing, to the social media account of the customer, a request to follow the merchant when the social media account fails to follow the merchant; or retaining the machine learning model based on whether the social media account of the customer follows the merchant.

In a sixth implementation, alone or in combination with one or more of the first through fifth implementations, process 700 may include performing a sentiment analysis of the customer with the merchant; and performing one or more other actions based on the sentiment analysis.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

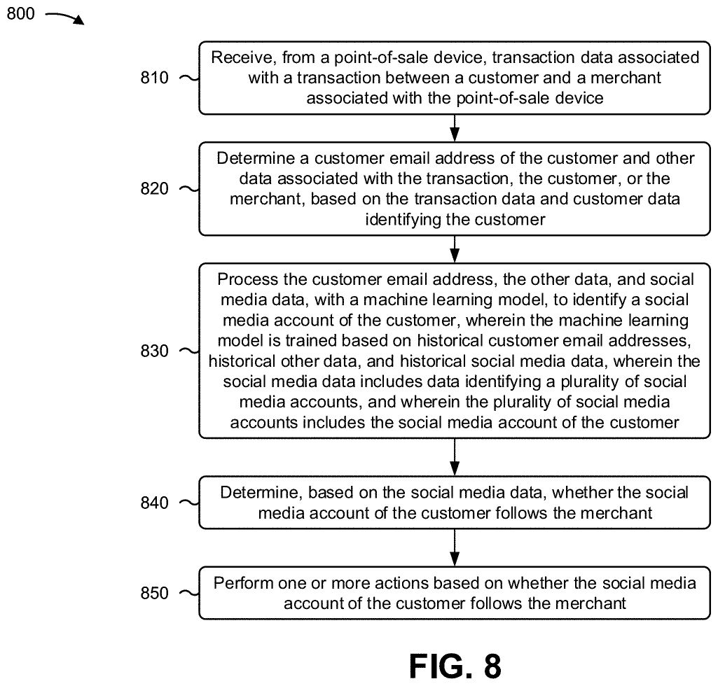

FIG. 8 is a flow chart of an example process 800 for utilizing machine learning to determine whether an in-person customer follows a merchant on social media. In some implementations, one or more process blocks of FIG. 8 may be performed by a device (e.g., processing platform 420). In some implementations, one or more process blocks of FIG. 8 may be performed by another device or a group of devices separate from or including the device, such as a client device (e.g., client device 410).

As shown in FIG. 8, process 800 may include receiving, from a point-of-sale device, transaction data associated with a transaction between a customer and a merchant associated with the point-of-sale device (block 810). For example, the device (e.g., using computing resource 424, processor 520, communication interface 570, and/or the like) may receive, from a point-of-sale device, transaction data associated with a transaction between a customer and a merchant associated with the point-of-sale device, as described above.

As further shown in FIG. 8, process 800 may include determining a customer email address of the customer and other data associated with the transaction, the customer, or the merchant, based on the transaction data and customer data identifying the customer (block 820). For example, the device (e.g., using computing resource 424, processor 520, memory 530, and/or the like) may determine a customer email address of the customer and other data associated with the transaction, the customer, or the merchant, based on the transaction data and customer data identifying the customer, as described above.

As further shown in FIG. 8, process 800 may include processing the customer email address, the other data, and social media data, with a machine learning model, to identify a social media account of the customer, wherein the machine learning model is trained based on historical customer email addresses, historical other data, and historical social media data, wherein the social media data includes data identifying a plurality of social media accounts, and wherein the plurality of social media accounts includes the social media account of the customer (block 830). For example, the device (e.g., using computing resource 424, processor 520, storage component 540, and/or the like) may process the customer email address, the other data, and social media data, with a machine learning model, to identify a social media account of the customer, as described above. In some implementations, the machine learning model may be trained based on historical customer email addresses, historical other data, and historical social media data. In some implementations, the social media data may include data identifying a plurality of social media accounts. In some implementations, the plurality of social media accounts may include the social media account of the customer.

As further shown in FIG. 8, process 800 may include determining, based on the social media data, whether the social media account of the customer follows the merchant (block 840). For example, the device (e.g., using computing resource 424, processor 520, memory 530, and/or the like) may determine, based on the social media data, whether the social media account of the customer follows the merchant, as described above.

As further shown in FIG. 8, process 800 may include performing one or more actions based on whether the social media account of the customer follows the merchant (block 850). For example, the device (e.g., using computing resource 424, processor 520, memory 530, storage component 540, communication interface 570, and/or the like) may perform one or more actions based on whether the social media account of the customer follows the merchant, as described above.

Process 800 may include additional implementations, such as any single implementation or any combination of implementations described below and/or in connection with one or more other processes described elsewhere herein.

In a first implementation, process 800 may include performing a sentiment analysis of the customer with the merchant; and performing one or more other actions based on the sentiment analysis.

In a second implementation, alone or in combination with the first implementation, performing the one or more actions based on whether the social media account of the customer follows the merchant, cause the one or more processors may include providing, to a client device of the customer, information indicating how to follow the merchant on social media when the social media account fails to follow the merchant; providing, to the point-of-sale device, information identifying an offer for the customer when the social media account follows the merchant; providing, to the point-of-sale device, information identifying a discount for the transaction when the social media account follows the merchant; providing a message to the social media account of the customer when the social media account follows the merchant; providing, to the social media account of the customer, a request to follow the merchant when the social media account fails to follow the merchant; or retaining the machine learning model based on whether the social media account of the customer follows the merchant.

In a third implementation, alone or in combination with one or more of the first and second implementations, determining, based on the social media data, whether the social media account of the customer follows the merchant may include determining, based on the social media data, whether the social media account of the customer follows the merchant, a product of the merchant, or a service of the merchant.

In a fourth implementation, alone or in combination with one or more of the first through third implementations, determining, based on the social media data, whether the social media account of the customer follows the merchant may include maintaining a list of social media accounts that follow the merchant; comparing the social media account of the customer to the list of social media accounts that follow the merchant; and determining whether the social media account of the customer follows the merchant based on comparing the social media account of the customer to the list of social media accounts that follow the merchant.

In a fifth implementation, alone or in combination with one or more of the first through fourth implementations, process 800 includes receiving, from the point-of-sale device, a name of another customer conducting another transaction with the merchant, an image of the other customer, and a geographical location of the merchant; processing the name of the other customer, the image of the other customer, the geographical location of the merchant, and the social media data, with another machine learning model, to identify another social media account of the other customer; determining, based on the social media data, whether the other social media account of the other customer follows the merchant; and performing one or more other actions based on whether the other social media account of the other customer follows the merchant.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device and from a point-of-sale device, transaction data associated with a transaction between a customer and a merchant associated with the point-of-sale device;
determining, by the device, a customer email address of the customer and other data associated with the transaction, the customer, or the merchant, based on the transaction data and customer data identifying the customer;
processing, by the device, the customer email address, the other data, and social media data, with a machine learning model, to identify a social media account of the customer,
wherein the social media data includes data identifying a plurality of social media accounts, and
wherein the plurality of social media accounts includes the social media account of the customer;
determining, by the device and based on the social media data, whether the social media account of the customer follows the merchant; and
performing, by the device, one or more actions based on whether the social media account of the customer follows the merchant.

2. The method of claim 1, wherein the other data includes data identifying one or more of:
an identifier of the transaction,
a geographical location of the transaction,
a name of the customer,
a geographical location of the merchant,
a geographical location of the customer,
an age of the customer, or
demographics associated with the customer.

3. The method of claim 1, further comprising:
performing a sentiment analysis of the customer with the merchant; and
performing one or more other actions based on the sentiment analysis.

4. The method of claim 1, wherein performing the one or more actions based on whether the social media account of the customer follows the merchant comprises one or more of:
providing, to a client device of the customer, information indicating how to follow the merchant on social media when the social media account fails to follow the merchant;
providing, to the point-of-sale device, information identifying an offer for the customer when the social media account follows the merchant; or
providing, to the point-of-sale device, information identifying a discount for the transaction when the social media account follows the merchant.

5. The method of claim 1, wherein performing the one or more actions based on whether the social media account of the customer follows the merchant comprises one or more of:
providing a message to the social media account of the customer when the social media account follows the merchant;
providing, to the social media account of the customer, a request to follow the merchant when the social media account fails to follow the merchant; or
retraining the machine learning model based on whether the social media account of the customer follows the merchant.

6. The method of claim 1, wherein determining, based on the social media data, whether the social media account of the customer follows the merchant comprises:
determining, based on the social media data, whether the social media account of the customer follows the merchant, a product of the merchant, or a service of the merchant.

7. The method of claim 1, wherein determining, based on the social media data, whether the social media account of the customer follows the merchant comprises:
maintaining a list of social media accounts that follow the merchant;
comparing the social media account of the customer to the list of social media accounts that follow the merchant; and
determining whether the social media account of the customer follows the merchant based on comparing the social media account of the customer to the list of social media accounts that follow the merchant.

8. A device, comprising:
one or more memories; and
one or more processors, communicatively coupled to the one or more memories, configured to:
receive, from a point-of-sale device, a name of a customer conducting a transaction with a merchant, an image of the customer, and a geographical location of the merchant;
process the name of the customer, the image of the customer, the geographical location of the merchant, and social media data, with a machine learning model, to identify a social media account of the customer;
determine, based on the social media data, whether the social media account of the customer follows the merchant; and
perform one or more actions based on whether the social media account of the customer follows the merchant.

9. The device of claim 8, wherein the name of the customer is received from a transaction card associated with the customer.

10. The device of claim 8, wherein the image of the customer is received from a camera associated with the point-of-sale device.

11. The device of claim 8, wherein the geographical location of the merchant includes a geographical location of the point-of-sale device.

12. The device of claim 8, wherein the one or more processors, when performing the one or more actions based on whether the social media account of the customer follows the merchant, are configured to one or more of:
provide, to a client device of the customer, information indicating how to follow the merchant on social media when the social media account fails to follow the merchant;
provide, to the point-of-sale device, information identifying an offer for the customer when the social media account follows the merchant; or
provide, to the point-of-sale device, information identifying a discount for the transaction when the social media account follows the merchant.

13. The device of claim 8, wherein the one or more processors, when performing the one or more actions based on whether the social media account of the customer follows the merchant, are configured to one or more of:
provide a message to the social media account of the customer when the social media account follows the merchant;
provide, to the social media account of the customer, a request to follow the merchant when the social media account fails to follow the merchant; or
retain the machine learning model based on whether the social media account of the customer follows the merchant.

14. The device of claim 8, wherein the one or more processors are further configured to:
perform a sentiment analysis of the customer with the merchant; and
perform one or more other actions based on the sentiment analysis.

15. A non-transitory computer-readable medium storing instructions, the instructions comprising:
one or more instructions that, when executed by one or more processors, cause the one or more processors to:
receive, from a point-of-sale device, transaction data associated with a transaction between a customer and a merchant associated with the point-of-sale device;
determine a customer email address of the customer and other data associated with the transaction, the customer, or the merchant, based on the transaction data and customer data identifying the customer;
process the customer email address, the other data, and social media data, with a machine learning model, to identify a social media account of the customer,
wherein the machine learning model is trained based on historical customer email addresses, historical other data, and historical social media data,
wherein the social media data includes data identifying a plurality of social media accounts, and
wherein the plurality of social media accounts includes the social media account of the customer;
determine, based on the social media data, whether the social media account of the customer follows the merchant; and
perform one or more actions based on whether the social media account of the customer follows the merchant.

16. The non-transitory computer-readable medium of claim 15, wherein the one or more instructions, when executed by the one or more processors, further cause the one or more processors to:
perform a sentiment analysis of the customer with the merchant; and
perform one or more other actions based on the sentiment analysis.

17. The non-transitory computer-readable medium of claim 15, wherein the one or more instructions, that cause the one or more processors to perform the one or more actions based on whether the social media account of the customer follows the merchant, cause the one or more processors to one or more of:
provide, to a client device of the customer, information indicating how to follow the merchant on social media when the social media account fails to follow the merchant;
provide, to the point-of-sale device, information identifying an offer for the customer when the social media account follows the merchant;
provide, to the point-of-sale device, information identifying a discount for the transaction when the social media account follows the merchant;
provide a message to the social media account of the customer when the social media account follows the merchant;
provide, to the social media account of the customer, a request to follow the merchant when the social media account fails to follow the merchant; or
retain the machine learning model based on whether the social media account of the customer follows the merchant.

18. The non-transitory computer-readable medium of claim 15, wherein the one or more instructions, that cause the one or more processors to determine, based on the social media data, whether the social media account of the customer follows the merchant, cause the one or more processors to:
determine, based on the social media data, whether the social media account of the customer follows the merchant, a product of the merchant, or a service of the merchant.

19. The non-transitory computer-readable medium of claim 15, wherein the one or more instructions, that cause the one or more processors to determine, based on the social media data, whether the social media account of the customer follows the merchant, cause the one or more processors to:
maintain a list of social media accounts that follow the merchant;
compare the social media account of the customer to the list of social media accounts that follow the merchant; and
determine whether the social media account of the customer follows the merchant based on comparing the social media account of the customer to the list of social media accounts that follow the merchant.

20. The non-transitory computer-readable medium of claim 15, wherein the one or more instructions, when executed by the one or more processors, further cause the one or more processors to:
receive, from the point-of-sale device, a name of another customer conducting another transaction with the merchant, an image of the other customer, and a geographical location of the merchant;
process the name of the other customer, the image of the other customer, the geographical location of the merchant, and the social media data, with another machine learning model, to identify another social media account of the other customer;
determine, based on the social media data, whether the other social media account of the other customer follows the merchant; and
perform one or more other actions based on whether the other social media account of the other customer follows the merchant.
